(19) United States
(12) Patent Application Publication
(10) Pub. No.: US 2023/0049742 A1
(43) Pub. Date: Feb. 16, 2023

(54) Lighted Seasoning Dispensing Device

(71) Applicant: Jeffrey Jennings, Moore Haven, FL (US)

(72) Inventor: Jeffrey Jennings, Moore Haven, FL (US)

(21) Appl. No.: 17/814,672

(22) Filed: Jul. 25, 2022

Related U.S. Application Data
(60) Provisional application No. 63/231,305, filed on Aug. 10, 2021.

(51) Int. Cl. A47G 19/24; B01F 33/501; B65D 43/02; B01F 31/441; A47J 47/01

(52) U.S. Cl. CPC A47G 19/24; B01F 33/50111; B65D 43/0225; B01F 31/441; A47J 47/01; B01F 2101/06

(57) ABSTRACT

The present invention relates to a novel, lighted seasoning dispensing device. The device is used in dimly lit environments, such as restaurants, bars, and outdoors at night. Specifically, the lighted seasoning dispensing device may be used for dispensing salt and/or spices to prevent over seasoning. The device comprises a handheld shaker with a plurality of holes at one end for dispensing salt and/or spices. The device also comprises a built-in LED lighting mechanism that is angled, such that it shines in the direction of the dispensing openings. The device operates on rechargeable batteries and utilizes a charging station which runs on solar power.

### CROSS-REFERENCE TO RELATED APPLICATION

The present application claims priority to, and the benefit of, U.S. Provisional Application No. 63/231,305, which was filed on Aug. 10, 2021 and is incorporated herein by reference in its entirety.

### FIELD OF THE INVENTION

The present invention relates generally to the field of saltshaker devices. More specifically, the present invention relates to an improved, lighted saltshaker device that provides users with a saltshaker with a built-in LED lighting mechanism. Specifically, the device operates on rechargeable batteries and is charged via a charging station, which runs on solar power. Accordingly, the present disclosure makes specific reference thereto. Nonetheless, it is to be appreciated that aspects of the present invention are also equally applicable to other like applications, devices and methods of manufacture.

### BACKGROUND

By way of background, chefs and servers in the restaurant and food service industries struggle with over-seasoned entrees and dealing with unhappy customers who receive them. This issue is especially prevalent with salt. High sodium intake is not good for the body, and patrons with underlying health issues often have restrictive diets that limit salt consumption. Adding too much salt or spices to a dish, greatly reduces the quality of taste for the dish. Often these meals must be thrown out and prepared again, resulting in lost time, wages, and labor. Utilizing a device that allows users to be cognizant of how much salt and/or spices they are adding to a dish, would be advantageous.

However, restaurants and bars are usually dimly lit. Thus, in lighting situations with poor visibility, it can be difficult to judge how much salt or spices you are adding to your dishes, resulting in over distribution. Further, users with visual impairments or some degree of visual decline, may also need additional lighting in some situations. Accordingly, a saltshaker device for use in dimly lit environments, such as restaurants, bars, and outdoors at night, etc., would be advantageous.

Therefore, a novel saltshaker device is needed that can provide for dispensing salt and/or spices without over seasoning. Further, a useful device is needed that allows use of the saltshaker device in dimly lit environments, such as restaurants, bars, and outdoors, at night.

Therefore, there exists a long-felt need in the art for a lighted saltshaker device that provides users with an improved device for dispensing salt and/or spices to prevent over seasoning. There is also a long-felt need in the art for a lighted saltshaker device for use in dimly lit environments, such as restaurants, bars, and outdoors at night. Further, there is a long-felt need in the art for a lighted saltshaker device that features an LED lighting mechanism integrated into the device for ease of use. Moreover, there is a long-felt need in the art for a device that includes rechargeable batteries and a solar powered docking station for charging. Further, there is a long-felt need in the art for a lighted saltshaker device that offers assistance for anyone with visual impairments or some degree of visual decline. Finally, there is a long-felt need in the art for a lighted saltshaker device that allows a user to more clearly see how much salt and/or spices they are distributing onto their food, ensuring that they do not exceed the desired amount.

The subject matter disclosed and claimed herein, in one embodiment thereof, comprises a lighted saltshaker device. The device is used in dimly lit environments, such as restaurants, bars, and outdoors at night. Specifically, the lighted saltshaker device is an improved device for dispensing salt and/or spices to prevent over seasoning. The device comprises a handheld shaker with a plurality of holes at one end for dispensing salt and/or spices. The device also comprises a built-in LED lighting mechanism that is angled, such that it shines in the direction of the dispensing openings. The device operates on rechargeable batteries and utilizes a charging station which runs on solar power. This allows a user to more clearly see how much salt and/or spices they are distributing onto their food, ensuring that they do not exceed the desired amount.

In this manner, the lighted saltshaker device of the present invention accomplishes all of the foregoing objectives and provides users with a device that is used in dimly lit environments. Further, the device offers assistance for anyone with visual impairments or some degree of visual decline. The device provides an improved saltshaker for dispensing salt and/or spices to prevent over seasoning.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a lighted saltshaker device. The device is used in dimly lit environments, such as restaurants, bars, and outdoors at night. Specifically, the lighted saltshaker device is an improved device for dispensing salt and/or spices to prevent over seasoning. The device comprises a handheld shaker component with a plurality of holes at one end for dispensing salt and/or spices. The device also comprises a built-in LED lighting mechanism that is angled, such that it shines in the direction of the dispensing openings. This allows a user to more clearly see how much salt and/or spices they are distributing onto their food, ensuring that they do not exceed the desired amount.

In one embodiment, the shaker component includes a cylindrical reservoir for the granular material, such as salt, spices, etc. The shaker component comprises a first end and a second end, with the first end being closed and sealed and the second end being open. The open second end allows access to the reservoir and allows a user to refill the reservoir with salt, spices, etc., when needed. The shaker component can be any suitable shape or size as is known in the art, but should have a comfortable feel for the user's hand.

In one embodiment, the shaker component is manufactured of glass or other suitable materials that can be seen through, to allow a user to view the contents of the cylindrical reservoir and know when more salt or spices need to be added. However, other suitable materials could also be used to manufacture the shaker component, such as polycarbonate, plastics or polymers, acrylic, etc.

In another embodiment, the open second end also includes a cap or lid component comprising a plurality of dispensing through holes or apertures for dispensing the contents of the reservoir. Typically, the lid component is screwed or threaded onto the open second end, but the lid component can be secured via any suitable securing means as is known in the art.

In one embodiment, the lid component is manufactured of metal, plastic or polymers, glass, etc., or any other suitable materials as is known in the art. Typically, the lid component and the shaker component are also manufactured from a material that is water resistant or water permeable, or comprises a coating that is water resistant or water permeable.

In one embodiment, the lid component also comprises a built-in LED lighting mechanism. The LED lighting mechanism comprises a plurality of LED lights in communication with a power button and/or sensor. The LED lights are powered via rechargeable batteries or other suitable power means as is known in the art. The LED lights would be activated via the power button or the sensor, and once triggered, the LED lights shine light at such an angle that the light shines in the direction of the plurality of dispensing holes, illuminating the dispensing of the salt or spices.

In one embodiment, the device operates on rechargeable batteries and utilizes a charging station which runs on solar power. The charging station can typically charge two devices at once, however any number of devices can be charged, depending on the size of the charging station used. Typically, in one embodiment, the charging station has 120 vac charging capabilities and charges two devices at once.

In one embodiment, the LED lights are controlled via a power button. A user merely pushes the power button on or off, to control the LED lights as needed. In another embodiment, the LED lights are controlled via a sensor. Specifically, the lighting mechanism comprises a dual axis gyro sensor which detects movements of the shaker component and automatically triggers the LED lights, which reflects off the contents being dispensed and illuminates them for a better visual. In use, when a user moves or rotates the shaker component to dispense salt or spices through the plurality of dispensing holes, the sensor is activated and the LED lights are automatically powered on.

In one embodiment, the shaker component and/or the lid component comprises a plurality of indicia.

In yet another embodiment, a method of allowing users to more clearly see how much salt or spices they are distributing onto their food, ensuring that they do not exceed the desired amount is disclosed. The method includes the steps of providing a lighted saltshaker device for dispensing salt and spices to prevent over seasoning. The method also comprises grasping the handheld shaker of the device to dispense salt or spices. Further, the method comprises automatically illuminating the LED lights when a sensor detects movement of the device. The method also comprises shaking the device to dispense the salt or spices while the contents are illuminated. Finally, charging the device by placing it on the docking station when not in use.

In yet another embodiment of the present invention, a lighted saltshaker device is disclosed for allowing a user to more clearly see how much salt or spice they are distributing onto their food, ensuring that they do not exceed the desired amount. The device comprises a shaker component with a plurality of dispensing holes at one end for dispensing salt or spice, etc. The device also comprises an LED lighting mechanism for illuminating the contents being dispensed. The LED lights are triggered via a power button and/or sensor, which allows light to be angled, such that it shines in the direction of the dispensing holes. The device operates on rechargeable batteries and is charged on a charging station, which runs on solar power. The lighted saltshaker device is a valuable tool for any cook or server in the restaurant business, as well as for amateur cooks everywhere.

Numerous benefits and advantages of this invention will become apparent to those skilled in the art to which it pertains, upon reading and understanding the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of the lighted saltshaker device of the present invention, wherein the LED light is illuminated while pouring salt from the dispenser in accordance with the disclosed architecture;

FIG. 2 illustrates a perspective view of another potential embodiment of the lighted saltshaker device of the present invention in accordance with the disclosed architecture;

FIG. 3 illustrates a perspective view showing a pair of one potential embodiment of the saltshaker devices being charged in accordance with the disclosed architecture;

FIG. 4 illustrates a perspective view of one potential embodiment of the solar powered charging dock for the lighted saltshaker device of the present invention in accordance with the disclosed architecture;

FIG. 5 illustrates a perspective view of one potential embodiment of the lighted saltshaker device of the present invention, wherein the lid is removable in accordance with the disclosed architecture; and

FIG. 6 illustrates a flowchart showing a method of illuminating a saltshaker device while pouring salt or other seasonings in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long-felt need in the art for a lighted saltshaker device that provides users with an improved device for dispensing salt and/or spices to prevent over seasoning. There is also a long-felt need in the art for a lighted saltshaker device for use in dimly lit environments, such as restaurants, bars, and outdoors at night. Further, there is a long-felt need in the art for a lighted saltshaker device that features an LED lighting mechanism integrated into the device for ease of use. Moreover, there is a long-felt need in the art for a device that includes rechargeable batteries and a solar powered docking station for charging. Further, there is a long-felt need in the art for a lighted saltshaker device that offers assistance for anyone with visual impairments or some degree of visual decline. Finally, there is a long-felt need in the art for a lighted saltshaker device that allows a user to more clearly see how much salt and/or spices they are distributing onto their food, ensuring that they do not exceed the desired amount.

The present invention, in one exemplary embodiment, is a novel, lighted saltshaker device. The device comprises a handheld shaker with a plurality of holes at one end for dispensing salt and/or spices. The device also comprises a built-in LED lighting mechanism that is angled, such that it shines in the direction of the dispensing openings. The device operates on rechargeable batteries and utilizes a charging station which runs on solar power. The present invention also includes a novel method of allowing users to more clearly see how much salt or spices they are distributing onto their food, ensuring that they do not exceed the desired amount. The method includes the steps of providing a lighted saltshaker device for dispensing salt and spices to prevent over seasoning. The method also comprises grasping the handheld shaker of the device to dispense salt or spices. Further, the method comprises automatically illuminating the LED lights when a sensor detects movement of the device. The method also comprises, shaking the device to dispense the salt or spices, while the contents are illuminated. Finally, charging the device by placing it on the docking station, when not in use.

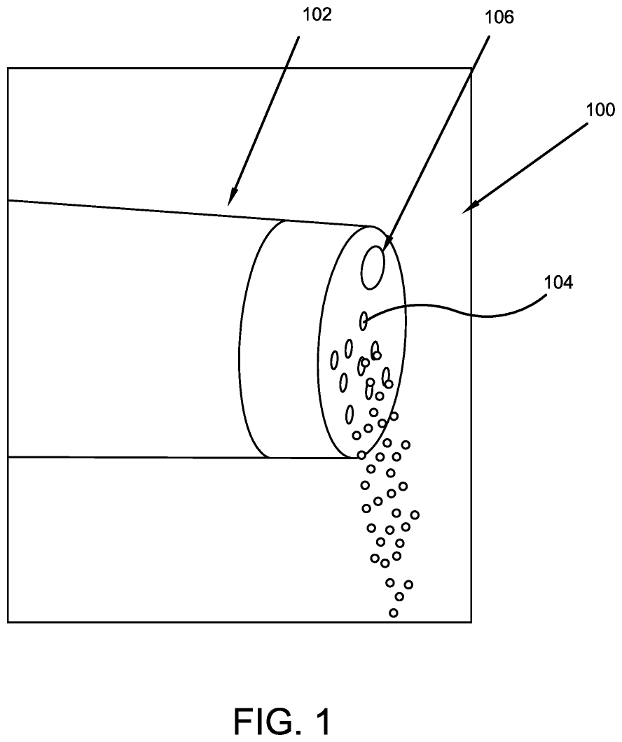

Referring initially to the drawings, FIG. 1 illustrates a perspective view of one embodiment of the lighted saltshaker device 100 of the present invention. In the present embodiment, the lighted saltshaker device 100 is an improved saltshaker device that can be used in dimly lit environments. The device 100 is especially designed to allow any cook or server in a restaurant, or amateur cooks, etc., or any other suitable user as is known in the art, to easily dispense salt and/or spices without over seasoning. More specifically, the device 100 comprises a handheld shaker component 102 with a plurality of dispensing holes 104 at one end for dispensing salt and/or spices. The device 100 also comprises a built-in LED lighting mechanism 106 that is angled, such that it shines in the direction of the dispensing openings or holes 104. This allows a user to more clearly see how much salt and/or spices they are distributing onto their food, ensuring that they do not exceed the desired amount.

Further, the shaker component 102 includes a cylindrical reservoir 108 for the granular material, such as salt, spices, etc., or any other suitable granular material as is known in the art, depending on the needs and/or wants of a user. Typically, the reservoir 108 is cylindrical, but can be any suitable shape as is known in the art. The shaker component 102 comprises a first end 110 and a second end 112, with the first end 110 being closed and sealed and the second end 112 being open. The open second end 112 allows access to the reservoir 108 and allows a user to refill the reservoir 108 with salt, spices, etc., when needed. The shaker component 102 can be any suitable shape or size as is known in the art, but should have a comfortable feel for the user's hand, allowing the user to hold the shaker component 102 without issue.

In one embodiment, the shaker component 102 is manufactured of glass or other suitable materials that can be seen through, to allow a user to view the contents of the cylindrical reservoir 108 and know when more salt or spices needs to be added. However, other suitable materials could also be used to manufacture the shaker component 102, such as acrylic, polycarbonate, plastics or polymers, such as polypropylene or acrylonitrile-butadiene-styrene (ABS), polyethylene, polyethylene terephthalate, polyvinyl chloride, etc., or any other suitable material as is known in the art.

Furthermore, the open second end 112 also includes a cap or lid component 114 comprising a plurality of dispensing through holes or apertures 104 for dispensing the contents of the reservoir 108. Typically, the lid component 114 is screwed or threaded onto the open second end 112, but the lid component 114 can be secured via any suitable securing means as is known in the art, such as press fit, snap fit, etc.

In one embodiment, the lid component 114 is manufactured of metal, plastic or polymers, glass, etc., or any other suitable materials as is known in the art. Typically, the lid component 114 and the shaker component 102 are also manufactured from a material that is water resistant or water permeable, or comprises a coating that is water resistant or water permeable.

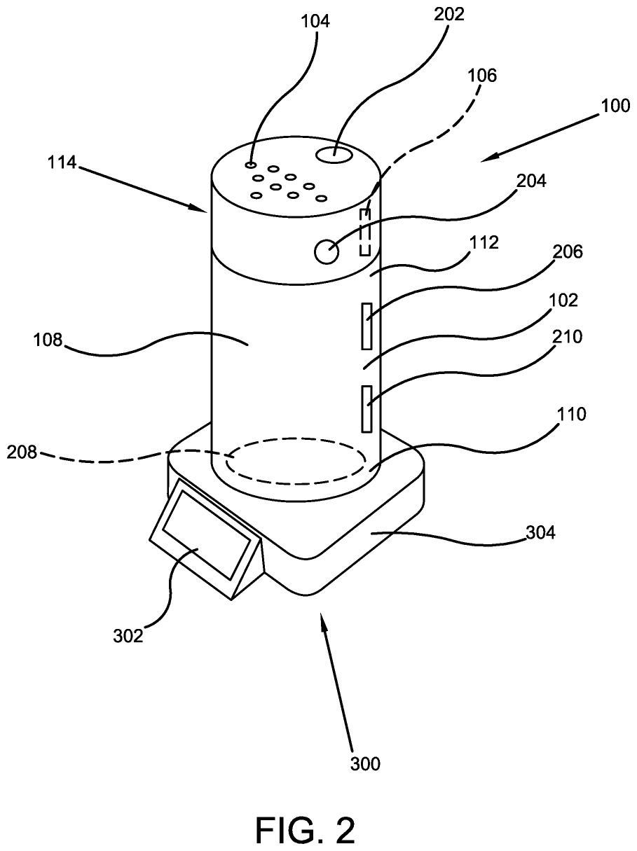

FIG. 2 illustrates a perspective view of another embodiment of the lighted saltshaker device 100 of the present invention. In this embodiment, the lid component 114 also comprises a built-in LED lighting mechanism 106. The LED lighting mechanism 106 comprises a plurality of LED lights 202 in communication with a power button 204 and/or sensor 206. The LED lights 202 are powered via rechargeable batteries 208 or other suitable power means as is known in the art. The LED lights 202 would be activated via the power button 204 or the sensor 206, and once triggered, the LED lights 202 shine light at such an angle that the light shines in the direction of the plurality of dispensing holes 104, illuminating the dispensing of the salt or spices.

Further, in one embodiment, the LED lights 202 are controlled via a power button 204. A user merely pushes the power button 204 on or off, to control the LED lights 202 as needed. In another embodiment, the LED lights 202 are controlled via a sensor 206. Specifically, the lighting mechanism 106 comprises a dual axis gyro sensor 210 which detects movements of the shaker component 102 and automatically triggers the LED lights 202, which reflect off the contents being dispensed and illuminates them for a better visual. In use, when a user moves or rotates the shaker component 102 to dispense salt or spices through the plurality of dispensing holes 104, the sensor 206 is activated and the LED lights 202 are automatically powered on. Other suitable sensors 206 can be utilized to control the LED lights 202, such as a mercury switch, etc., or any other sensor as is known in the art, depending on the needs and/or wants of a user.

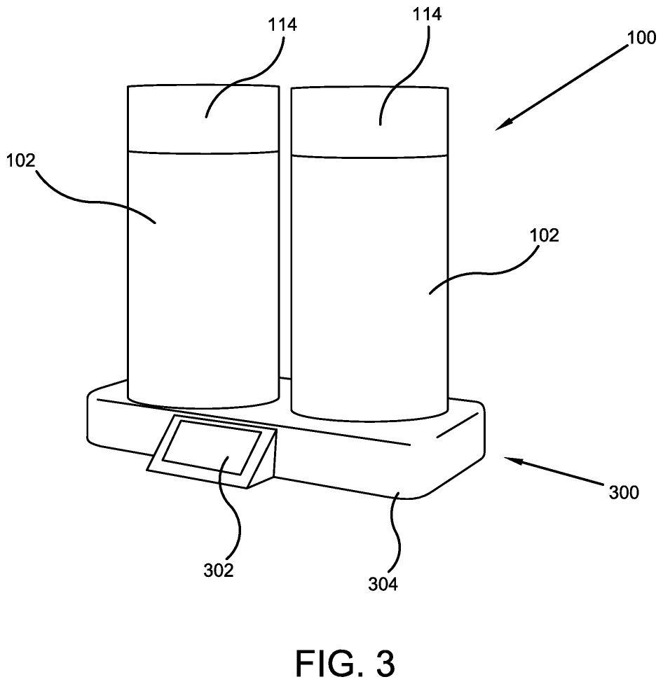

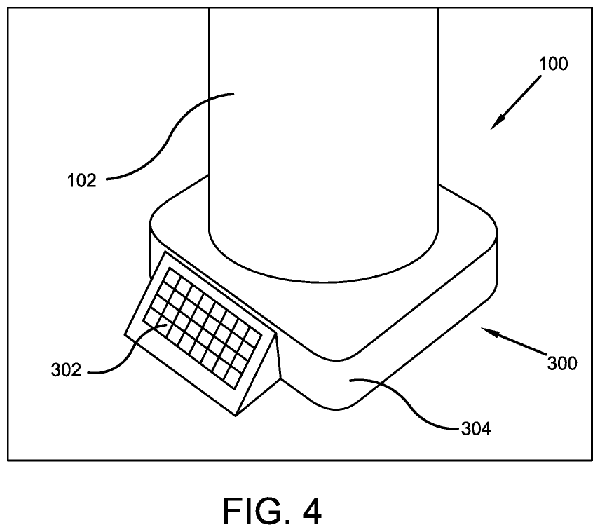

FIGS. 3-4 illustrate a perspective view of another embodiment of the lighted saltshaker device 100 of the present invention. In this embodiment, the device 100 operates on rechargeable batteries 208 and utilizes a charging station 300 which runs on solar power. Specifically, the charging station 300 includes a plurality of solar panels 302 on the dock 304 of the charging station 300 to charge the batteries 208 of the device 100. The charging station 300 can typically charge two devices 100 at once, however any number of devices 100 can be charged, depending on the size of the charging station 300 used. Typically, in one embodiment, the charging station 300 has 120 vac charging capabilities and charges two devices 100 at once, as shown in FIG. 3.

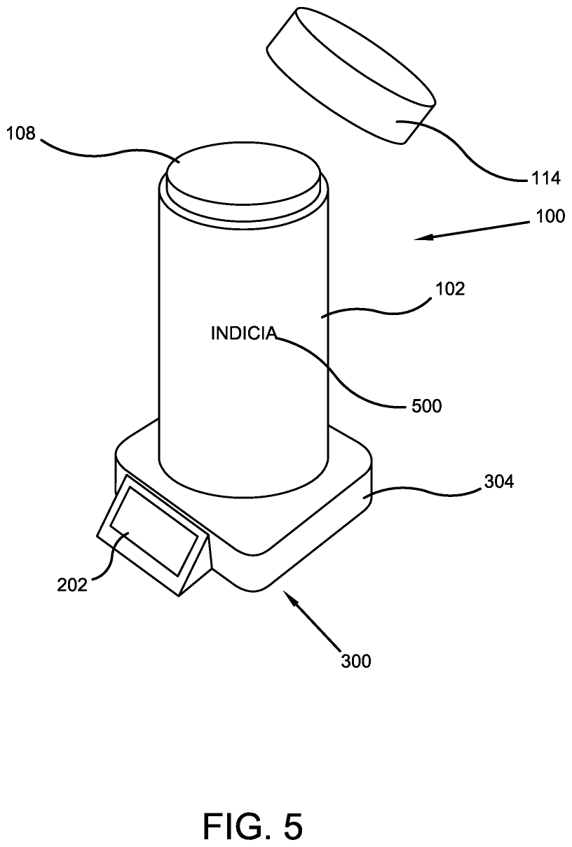

FIG. 5 illustrates a perspective view of another embodiment of the lighted saltshaker device 100 of the present invention. In this embodiment, the shaker component 102 and/or the lid component 114 comprise a plurality of indicia 500. Specifically, the shaker component 102 and/or the lid component 114 may include advertising, a trademark, or other letters, designs, or characters, printed, painted, stamped, or integrated into the shaker component 102 and/or the lid component 114, or any other indicia 500 as is known in the art. Specifically, any suitable indicia 500 as is known in the art can be included, such as, but not limited to, patterns, logos, emblems, images, symbols, designs, letters, words, characters, animals, advertisements, brands, etc., that may or may not be restaurant/brand related.

In yet another embodiment of the present invention, a lighted saltshaker device 100 is disclosed for allowing a user to more clearly see how much salt or spice they are distributing onto their food, ensuring that they do not exceed the desired amount. The device 100 comprises a shaker component 102 with a plurality of dispensing holes 104 at one end 112 for dispensing salt or spice, etc. The device 100 also comprises an LED lighting mechanism 106 for illuminating the contents being dispensed. The LED lights 202 are triggered via a power button 204 and/or sensor 206, which allows light to be angled, such that it shines in the direction of the dispensing holes 104. The device 100 operates on rechargeable batteries 208 and is charged on a charging station 300, which runs on solar power. The lighted saltshaker device 100 is a valuable tool for any cook or server in the restaurant business, as well as for amateur cooks everywhere.

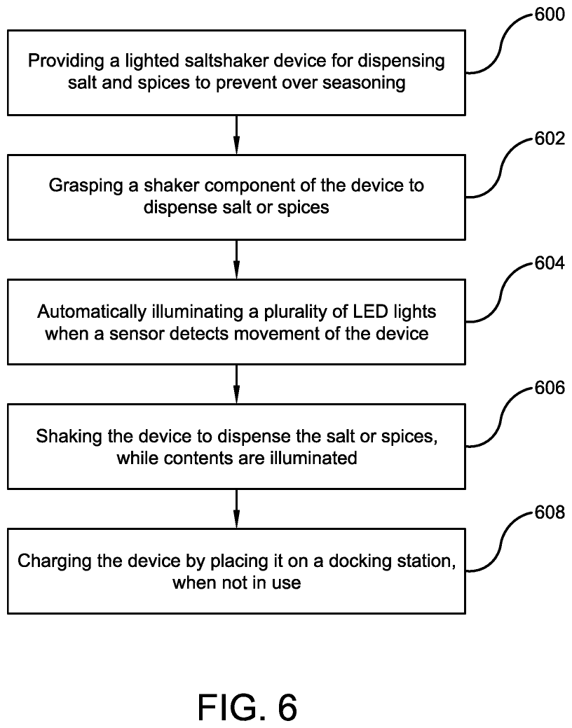

FIG. 6 illustrates a flowchart of the method of allowing users to more clearly see how much salt or spices they are distributing onto their food, ensuring that they do not exceed the desired amount. The method includes the steps of at 600, providing a lighted saltshaker device for dispensing salt and spices to prevent over seasoning. The method also comprises at 602, grasping the handheld shaker of the device to dispense salt or spices. Further, the method comprises at 604, automatically illuminating the LED lights when a sensor detects movement of the device. The method also comprises at 606, shaking the device to dispense the salt or spices, while the contents are illuminated. Finally, at 608, charging the device by placing it on the docking station when not in use.

Certain terms are used throughout the following description and claims to refer to particular features or components. As one skilled in the art will appreciate, different users may refer to the same feature or component by different names. This document does not intend to distinguish between components or features that differ in name but not structure or function. As used herein “lighted saltshaker device”, “saltshaker device”, and “device” are interchangeable and refer to the lighted saltshaker device 100 of the present invention.

Notwithstanding the foregoing, the lighted saltshaker device 100 of the present invention can be of any suitable size and configuration as is known in the art without affecting the overall concept of the invention, provided that it accomplishes the above stated objectives. One of ordinary skill in the art will appreciate that the lighted saltshaker device 100 as shown in FIGS. 1-6 is for illustrative purposes only, and that many other sizes and shapes of the lighted saltshaker device 100 are well within the scope of the present disclosure. Although the dimensions of the lighted saltshaker device 100 are important design parameters for user convenience, the lighted saltshaker device 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A lighted seasoning dispensing device for use in a dimly lit environment, the lighted seasoning dispensing device comprising:
a shaker component comprising a first end, a second end and a reservoir for retaining a granular material, wherein the first end of the shaker component is closed and sealed and the second end of the shaker component is open;
a lid component comprising a plurality of dispensing holes; and
an LED lighting mechanism that shines a light at an angle in a direction of the plurality of dispensing holes, thereby allowing a user to more clearly see how much of the granular material is being dispensed from the reservoir.

2. The lighted seasoning dispensing device of claim 1, wherein the granular material is a salt.

3. The lighted seasoning dispensing device of claim 2, wherein the lid component is secured to the second end of the shaker component.

4. The lighted seasoning dispensing device of claim 3, wherein the lid component is threaded onto the second end of the shaker component.

5. The lighted seasoning dispensing device of claim 4 wherein the LED lighting mechanism comprises a plurality of LED lights.

6. The lighted seasoning dispensing device of claim 5, wherein the plurality of LED lights are in communication with a power button.

7. The lighted seasoning dispensing device of claim 6, wherein the plurality of LED lights are in communication with a sensor.

8. The lighted seasoning dispensing device of claim 7, wherein the sensor is a dual axis gyro sensor.

9. The lighted seasoning dispensing device of claim 6, wherein the plurality of LED lights are powered via a rechargeable battery.

10. The lighted seasoning dispensing device of claim 9 further comprising a charging station for charging the rechargeable battery.

11. The lighted seasoning dispensing device of claim 10, wherein the charging station is solar powered.

12. The lighted seasoning dispensing device of claim 1, wherein at least one of the shaker component or the lid component comprises a plurality of indicia.

13. A lighted seasoning dispensing device for use in a dimly lit environment, the lighted seasoning dispensing device comprising:
a shaker component comprising a first end, a second end and a reservoir for retaining a granular material, wherein the first end of the shaker component is closed and sealed and the second end of the shaker component is open;
a lid component comprising a plurality of dispensing holes for dispensing the granular material therethrough;
a plurality of LED lights; and
a power button.

14. The lighted seasoning dispensing device of claim 13 further comprising a dual axis gyro sensor.

15. The lighted seasoning dispensing device of claim 13 wherein the plurality of LED lights are powered via a rechargeable battery.

16. The lighted seasoning dispensing device of claim 15 further comprising a charging station for charging the rechargeable battery.

17. The lighted seasoning dispensing device of claim 16, wherein the charging station is configured to charge a pair of lighted seasoning dispensing devices simultaneously.

18. The lighted seasoning dispensing device of claim 17, wherein the charging station is solar powered.

19. The lighted seasoning dispensing device of claim 13, wherein at least one of the shaker component or the lid component comprises a plurality of indicia.

20. A method of allowing a user to more clearly see how much of a seasoning is being dispensed onto a food to ensure that a desired amount is not exceeded, the method comprising the steps of:
providing a lighted seasoning dispensing device for dispensing the seasoning to prevent over seasoning, wherein the a lighted seasoning dispensing device comprises a plurality of LED lights and a sensor;
grasping a shaker component of the lighted seasoning dispensing device to dispense the seasoning;
automatically illuminating the plurality of LED lights when the sensor detects a movement of the lighted seasoning dispensing device;
shaking the lighted seasoning dispensing device to dispense the seasonings while illuminated by the plurality of LED lights; and
charging the lighted seasoning dispensing device by placing it on a docking station when not in use.
